(19) United States
(12) Patent Application Publication
(10) Pub. No.: US 2025/0348922 A1
(43) Pub. Date: Nov. 13, 2025

(54) SYSTEMS AND METHODS FOR PRODUCT RETRIEVAL

(71) Applicant: Walmart Apollo, LLC, Bentonville, AR (US)

(72) Inventors: Michael A. Garner, Centerton, AR (US); Matthew B. Lindsey, Centerton, AR (US); Robert Lutczyk, Redwood City, CA (US)

(21) Appl. No.: 19/277,798

(22) Filed: Jul. 23, 2025

Related U.S. Application Data
(63) Continuation of application No. 17/652,973, filed on Mar. 1, 2022.
(60) Provisional application No. 63/155,235, filed on Mar. 1, 2021.

(51) Int. Cl. G06Q 30/0601; G06Q 10/087; G06Q 20/20; G06Q 30/0201

(52) U.S. Cl. CPC G06Q 30/0639; G06Q 10/087; G06Q 20/20; G06Q 30/0201; G06Q 30/0635

(57) ABSTRACT

Systems, apparatuses, devices, applications, and methods are provided herein useful to provide retrieval of products within a retail store and control a point of sale system to execute purchase of a product list in conjunction with a mobile device. A device control circuit of the mobile device is configured to receive a proposed product list from a respective customer; determine a suggested product list based on the proposed product list and a weighted average of a plurality of variables; determine a shopping route for the suggested product list, reduce the duration of the shopping route if possible, acquire payment from the respective customer for products on a final product list, and control the point of sale system to execute purchase of the products on the final product list on behalf of the respective customer.

### CROSS-REFERENCE TO RELATED APPLICATION(S)

This application is a continuation of U.S. application Ser. No. 17/652,973 filed Mar. 1, 2022, which claims the benefit of U.S. Provisional Application No. 63/155,235 filed Mar. 1, 2021, which are incorporated herein by reference in their entirety.

### TECHNICAL FIELD

This invention relates generally to retrieval of retail products and, more specifically, systems and methods for retrieval of products in a retail store.

### BACKGROUND

The rise of e-commerce as a common method of shopping has changed the landscape of retail shopping and the expectations by customers of the customer experience. In contrast to the days of shopping as a leisure activity, customers want and expect their shopping experience to be safe, convenient, and fast. While online shopping has increased, in person retail shopping is still a necessity, especially for customers who have less access and/or familiarity with shopping online and/or other retail delivery services. Moreover, certain “at-risk” customers may not feel safe or comfortable entering a retail store to have their order fulfilled. Similarly, mobility challenged customers may also prefer to remain in their vehicles rather than browse aisles and brave crowds within a retail store.

### BRIEF DESCRIPTION OF THE DRAWINGS

Disclosed herein are embodiments of systems, apparatuses and methods pertaining to product retrieval in a retail store. This description includes drawings, wherein:

FIG. 1 is an illustration of an exemplary system having its components coupled to a network, the system being suitable for use in implementing methods, techniques, devices, apparatuses, servers, sources and providing access to shopping in retail environments, in accordance with some embodiments.

FIG. 2 is a block diagram of an exemplary mobile device for use in implementing the systems and methods for product retrieval, in accordance with some embodiments.

FIG. 3 is an illustration of a retail store and surrounding geographic perimeter in accordance with a product retrieval system, in accordance with some embodiments.

FIG. 4 is an illustration of the inside of a retail store and exemplary shopping routes of two different customers using the mobile device provided herein, in accordance with some embodiments.

FIG. 5 is an illustration of an exemplary display showing products on a proposed product list, a suggested product list, and a final product list, in accordance with some embodiments.

FIG. 6 is an overview of a method of controlling a point of sale system to execute purchase of products on a final product list, in accordance with some embodiments.

FIG. 7 is a more detailed method of controlling a point of sale system to execute the purchase of products on a final product list using a mobile device and device control circuit, in accordance with some embodiments.

FIG. 8 is second method of executing the purchase of products using the system and devices herein, in accordance with some embodiments.

FIGS. 9-12 are illustrations of various views of a display of the user interface of a mobile device performing some of the steps of the methods of performing product retrieval, in accordance with some embodiments.

FIG. 13 illustrates a simplified representation of an exemplary graphical user interface to enable concierge selection of products to be incorporated into the suggested product list, in accordance with some embodiments.

FIG. 14 illustrates a simplified representation of an exemplary summary product list graphical user interface that enables a concierge to confirm when a product in the summary product list is retrieved, in accordance with some embodiments.

FIG. 15A is simplified illustration of system for product retrieval in which a mobile device retrieves information directly from a cloud-based item database accessible over a network, according to some embodiments.

FIG. 15B is a simplified illustration of the system of FIG. 15A after product information has been synchronized on a mobile device, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for product retrieval within a retail store. The embodiments are useful, in part, for coordinating the touch-less shopping of a customer who may drive up to a retail store and be greeted by a “concierge” (e.g., retail store employee, autonomous or unmanned vehicle operating a mobile device, partially autonomous device, interface and/or intercom system (e.g., typically with one or more displays, one or more touch screens, one or more cameras, one or more keyboards, one or more audio detections systems, and/or other such system components), other such systems or a combination of two or more of such systems). In some embodiments, the concierge will authenticate the customer, make note of various customer identifying information such as personal or vehicle related information. Personal information may include but is not limited to, for example, one or more of a customer's name, phone number, payment information, address, retail membership number. Vehicle information may include but is not limited to, one or more of, the make, model, color of the customer's car. More particularly, in an embodiment, an identity of each of a plurality of customers is obtained by a respective one of the plurality of mobile devices, and the identity is obtained based on at least one of: a vehicle feature, a retail store membership card, a government issued ID, a bank card, and a personalized membership code issued by the retail store.

In some embodiments, collection and use of the personal information and/or identifying information is only maintained for a single transaction or shopping trip, while in other implementations some or all of the personal or identifying information is maintained, such as in a customer profile corresponding to the customer. In some embodiments, the mobile device may display a set of products, the set of products corresponding to the customer's recent purchase history. Easy access category buttons at the top of the screen allow the mobile device to quickly display highly sought item categories such as cleaning products, snacks, etc. The mobile device may be configured to enable fast offline (i.e., disconnected from the network) searching for products. As such, a retail store inventory list may be stored in memory locally on the mobile device). On-hand quantities and limits may also be displayed on the mobile device. Because the mobile device is communicatively coupled to the inventory management system of the retail store, the system will not allow a customer to select a quantity larger than the limit to be selected.

Once the customer's order has been taken, in some embodiments, the concierge enters the store with the mobile device to fulfill the order and the customer is directed to park in a specified cordoned area. Alternatively, upon arrival, each customer parks in a designated area where the concierge greets them, and each customer remains in that parking spot throughout the duration of the shopping experience. In an embodiment, a concierge may simply locate most products and place them into the cart, but certain products may be priced by the pound and must be scanned as they are placed into the cart. For quality purposes, an associate within the retail store is encouraged to scan products as they are placed into the cart. In an embodiment, the mobile device may be used for use as a product scanning function, either in place of, or in communication with a point of sale device, to coordinate and execute purchase and/or collection of payment for purchase of the products.

The system herein may also shorten the duration of the shopping trip of one or more customers by incorporating information from another customer's concurrent shopping trip. For example, a concierge retrieving the same or similar products from one location may retrieve a product needed by another customer and place it at a closer retrieval point. This process will be described in further detail below. At the end of the shopping trip, after the products are purchased, a receipt of the shopping list may be electronically sent (e.g., emailed, texted) to the customer. Embodiments of the systems and devices herein may ultimately cause products on the final product list to be delivered to the customer at a customer's vehicle located outside of the retail store, or at a designated customer pickup area. In an embodiment, an unmanned vehicle coupled to the sensing system and at least one of the plurality of mobile devices causes the products to be delivered.

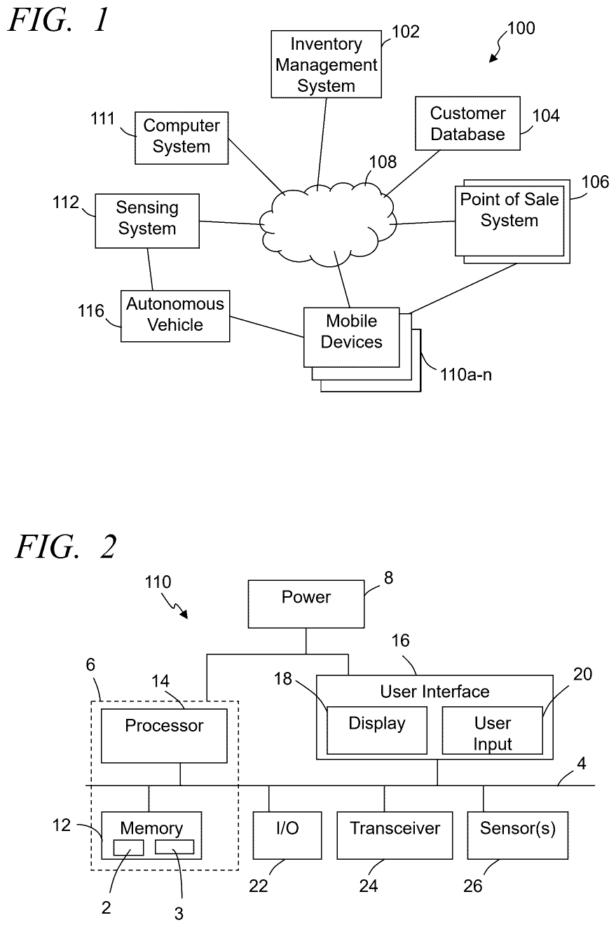

FIG. 1 is an illustration of an exemplary system 100 of networked components for use in implementing methods, techniques, devices, apparatuses, systems, servers, sources and providing access to product retrieval within retail environments, in accordance with some embodiments. For example, the system 100 includes an inventory management systems 102, customer databases 104, one or more point of sale system 106, one or more mobile devices 110a-n, a computer system 111 (e.g., a centralized computer system), a sensing system 112, one or more optional unmanned vehicles 116, and/or other such components, systems, circuitry, functionality and/or devices. Use of the system 100 is not dependent on any one component or portion thereof. Each of the components are connected to a communications network 108 (e.g., LAN, WAN, Internet, Wireless Network). As illustrated, an optional unmanned vehicle 116 may be connected to one or more of the sensing system 112, the mobile devices 110a-n, and/or alternatively directly to the network 108. The unmanned vehicle 116 may be utilized to obtain the proposed product and/or suggest product lists from the customer. Additionally, or alternatively, the unmanned vehicle 116 may be used for delivery of the purchased items on a final product list.

In some embodiments, one or more of the unmanned vehicles 116 may be operated autonomously. Additionally, or alternatively, the unmanned vehicle may be operated based on specific instructions received from a computer system 111 or operate semi-autonomously by, in part, receiving a listing of products and autonomously determining routing for a shopping trip of a customer. In an embodiment, one or more unmanned vehicles 116 may be controlled by the computer system 111 by receiving routing instructions from the processor of the computer system 111. In an embodiment, an unmanned vehicle 116 executes instructions received from the computer system 111 based on sensor data obtained from the sensing system 112.

In some embodiments, the sensing system 112 may include one or more sensors to provide information to the system 100 and/or sensor information that is communicated to another component within the system 100, for example, the computer system 111, an unmanned vehicle 116, or one or more of the mobile devices 110a-n, etc. The sensing system 112 may include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, image capture systems, motion sensor systems, and other such sensors. The foregoing examples are intended to be illustrative and are not intended to convey an exhaustive listing of all possible sensors. Instead, it will be understood that these teachings will accommodate sensing any of a wide variety of circumstances in a given application setting. The sensing system 112 may be configured to determine an arrival and a location of the plurality of customers 114a-n in a predetermined proximity to the retail store and/or sensor data is communicated to the computer system 111, the mobile devices 110 and/or other components of the system 100 that use the sensor data from the sensor systems to detect customers and/or their vehicles, determine that customers and/or their vehicles are within a predetermined proximity to the retail store, identify a particular parking spot that a customer's vehicle is parked, determine a departure of a customer and/or customer vehicle, and/or make other such determinations based on the sensor data.

The inventory management system 102 continuously maintains a current inventory of each product offered for sale by the retail store based on input received from the point of sale systems 106, shipping information of products ordered and/or received, product disposal information, virtual shopping cart information from the mobile devices 110, remote sales (e.g., phone orders, on-line orders, etc.), and other such information. In some embodiments, the inventory management system 102 maintains one or more inventory databases that stores the current inventory of the products. The customer database 104 stores a plurality of primary customer accounts of different customers. Typically, these customers have previously registered and/or purchased products from one or more of multiple different retail stores associated with the product purchase and retrieval system 100 including the specific location of the retail store from which the customer is seeking to purchase products. The customer accounts may include information relevant to each individual customer, and typically includes unique information specific to that customer. Such customer information includes one or more of, but is not limited to, customer identifying information (e.g., name, address, uniquely assigned customer identifier number), shopping preferences and/or partiality vectors, shopping and/or purchase history information, product likes and/or dislikes, product ratings specified by the customer, payment information (e.g., one or more methods of payment maintained in an electronic wallet associated with the customer, gift card information, etc.), address information, shipping and/or delivery history information, other such information, and typically a combination of two or more of such information. A point of sale system 106 is communicatively coupled over the communication network 108 with the inventory management system 102. The point of sale system 106 may include one or a plurality of apparatuses for accepting and processing payment for products. In an embodiment, the point of sale system 106 is communicatively coupled to the mobile device(s) 110. In another embodiment, the mobile device 110 may perform all or a portion of the functions of the point of sale system 106. For example, the mobile device 110 may be configured to perform a product scanning function, and/or may also be configured to execute purchase of the products on the final product list.

One or a plurality of mobile devices 110a-n, as illustrated, are coupled to the communication network 108 and are able to wirelessly communicate with the inventory management system 102 and the customer database 104. The mobile devices 110 include smartphones, tablets, retail store specific mobile device, scanners systems, wearable devices (e.g., optical head mounted displays (e.g., smart glasses, augmented reality glasses, display masks, etc.), smart watches, etc.)), and other such devices configured to enable interaction with the mobile device 110 and provide a user with access to the product listings and other relevant information as described below. In some embodiments, the mobile device 110 is owned by the concierge associate and implements a proprietary application to obtain shopping lists and routes as described below. The optional unmanned vehicle(s) 116 may also be coupled to the sensing system 112 and at least one of the plurality of mobile devices 110a-n. The unmanned vehicle 116 may be configured to perform a shopping route and cause products to be delivered from a final product list to the relevant customer at the customer's vehicle or other designated area outside of the retail store.

The computer system 111 may be coupled to the communication network 108. The computer system 111 may have a main data storage unit for storing the current inventory from the inventory management system 102, such that the computer system 111 is configured to store a copy of the current inventory in a local memory 12 within each of the plurality of mobile devices 110. In some embodiments, each mobile device 110 communicates with the inventory management system 102 and periodically and/or continuously maintains a local inventory database of at least some products and typically all of the products of the retail store enabling rapid identification of availability and selection of relevant products. In an embodiment, if connectivity to the communication network 108 is lost, one or more of the mobile devices 110 that lost connectivity and/or each of the plurality of mobile devices 110a-n automatically updates the copy of the current inventory list stored on a local memory of a mobile device 110 by accessing the main data storage unit of the computer system 111, when connectivity to the communication network 108 is regained. The mobile devices 110a-n may be used within the system 100 to implement one or more of the above or below, or parts of, components, circuits, systems, processes and the like.

Further, the circuits, circuitry, systems, devices, processes, methods, techniques, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, processes, or devices of the system 100 of FIG. 1, and/or other above or below mentioned systems or devices, or parts of such circuits, circuitry, functionality, systems, apparatuses, processes, or devices. For example, the system 1 may be used to implement some or all of one or more of the mobile devices 110, the computer system 111, the inventory management system 102, the sensing systems 112, the point of sale systems 106, the autonomous vehicles 116, and/or other such components, circuitry, functionality and/or devices. However, the use of the system 200 or any portion thereof is certainly not required.

FIG. 2 is generally described below with reference to an exemplary mobile device 110 for use in implementing the systems and methods for product retrieval, in accordance with some embodiments. While FIG. 2 is described herein as illustrating the mobile device 110, the components illustrated in FIG. 2 may also be used to implement other components of the system 100 of FIG. 1 (e.g., an inventory management system 102, customer databases 104, one or more point of sale system 106, sensing system 112, unmanned vehicles 116 etc.). As such, one of ordinary skill in the art would understand that the processing and functionality of the components of system 100 may be implemented using processors, memory, communication links, user interfaces etc. in order to achieve the intended benefits described herein. Furthermore, the components of system 100 may also include other structural features not explicitly illustrated, but that are also envisioned within the scope of this disclosure to cooperatively perform the steps and methods herein. For example, an unmanned vehicle 116 may include a motor, wheels, location tracking and other local processing and sensing systems in order to perform the steps with respect to the systems and methods, according to some embodiments.

Mobile device 110, is an example of the mobile devices 110a-n illustrated in system 100. Mobile device 110 may comprise a device control circuit 6, the device control circuit 6 having a processor 14 or processor module, a memory 12, and one or more communication links 4 (e.g., paths, buses, etc.). Some embodiments may include one or more user interfaces 16, and/or one or more internal and/or external power sources or power supplies 8. The device control circuit 6 may be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc.

Further, in some embodiments, the device control circuit 6 may be part of control circuitry and/or a control system, which may be implemented through one or more processors with access to one or more units of memory 12 that can store instructions, code and the like that is implemented by the device control circuit 6 and/or processors to implement intended functionality. In some embodiments, the memory 12 includes an operating system 2 and one or more applications 3 stored in memory. The application 3, when executed, in cooperation with the device control circuit 6, may control the mobile device 110 and cause the mobile device 110 to perform all or a portion of the steps for providing retrieval of products within a retail store. In some embodiments, the device control circuit 6 and/or memory 12 may be distributed over the communications network 108 providing distributed and/or redundant processing and functionality. In an embodiment, the device control circuit 6 is configured to receive a proposed product list of the respective customer without requiring a preestablished secondary electronic account of a respective customer. In an embodiment, the user credentials and/or the customer's credentials and identifying information are received by the application 3 executed on the respective mobile device 110 (e.g., via a user input device of the mobile device 110). In some embodiments, the application 3 executed on the mobile device 110 accesses, or causes the mobile device to access, a server system on the communication network 108.

The user interface 16 may allow a user (e.g., retail store shopper, customer, autonomous vehicle, AI device) to interact with the mobile device 110 and receive and send information through the network 108 to other components within the system 100. In some instances, the user interface 16 includes a display 18 and/or one or more user input devices 20, such as buttons, touch screen, track ball, keyboard, mouse, etc., which can be part of, wired to, or wirelessly coupled to the mobile device 110. Typically, the mobile device 110 further includes one or more communication interfaces, ports, transceivers 24 and the like allowing the mobile device 110 to communicate over a communication bus, a distributed computer and/or communication network 108 (e.g., a local area network (LAN), the Internet, wide area network (WAN), etc.), communication link 4, other networks or communication channels with other devices and/or other such communications or combination of two or more of such communication methods. Further the transceiver 24 can be configured for wired, wireless, optical, fiber optical cable, satellite, or other such communication configurations or combinations of two or more of such communications.

Some embodiments include one or more input/output (I/O) interface of ports 22 that allow one or more mobile devices 110a-n to couple with the system 100. The I/O ports 22 can be substantially any relevant port or combinations of ports, such as but not limited to USB, Ethernet, or other such ports. The I/O ports 22 can be configured to allow wired and/or wireless communication coupling to external components. For example, the I/O port 22 can provide wired communication and/or wireless communication (e.g., Wi-Fi, Bluetooth, cellular, RF, and/or other such wireless communication) over the communication network 108, and in some instances may include any known wired and/or wireless interfacing device, circuit and/or connecting device, such as but not limited to one or more transmitters, receivers, transceivers, or combination of two or more of such devices.

The mobile device 110 may also include one or more sensors 26 or a local sensing system. The sensor 26 may be in communication with the sensing system 112. The sensor 26 may provide a signal to the mobile device 110 of the presence of a customer entering the retail store perimeter. The sensor 26 may also be configured to supply the user interface 16 with information related to the arrival or anticipated arrival of a specific customer among other functions. The sensor(s) 26 may include one or more location sensors (e.g., GPS, wireless antenna triangulation, accelerometers, gyroscopes, RFID, camera, etc.) to track location of the user/mobile device 110 and aid in guiding the concierge and/or a first store associate along the intended shopping route and/or update the route (e.g., based on a second store associate being assigned to retrieve one of the products previously intended to be retrieved by the first store associate). The sensor 26 may also include one or more cameras that can be used by the concierge and/or store associates to capture information about one or more products in identifying a product and/or confirming retrieval of a product from the shopping list.

In some embodiments, the mobile device 110 includes one or more applications 3. The application 3 comprises computer program code that is configured to be installed on and executed by the mobile device (e.g., by a processor of the mobile device 110). The application 3 can be executed by the mobile device 110 in concert with other software modules or other applications (computer program code), or groups of applications, such as operating systems 2, positioning applications (e.g., a mapping, GPS, etc. applications), two-factor authentication (TFA) applications, single sign on (SSO) applications, graphics processing applications, security applications, camera applications, etc. In one embodiment, the application 3 is a concierge application, the inventory management system 102, and/or other applications as described herein. In such embodiments, the application can be a dedicated application (e.g., an application specific to a retailer or to inventory management tasks) or a general application that while not a “dedicated application” can perform the functions as described herein with respect to the inventory management system 102. In some embodiments, the application 3 is an add-on application installed on the mobile device 110 and that cooperates with other application/s of the mobile device 110, such as the operating system 2 and works with the other application/s to provide the functionality described herein. For example, in the embodiment illustrated in FIG. 2, the application 3 is an add-on application that communicates with the operating system 2 of the mobile device 110 to control and receive data from at least the display 18 and the user input device 20. In some embodiments, the application 3 is integral with other application/s of the mobile device 110 such as the operating system 2.

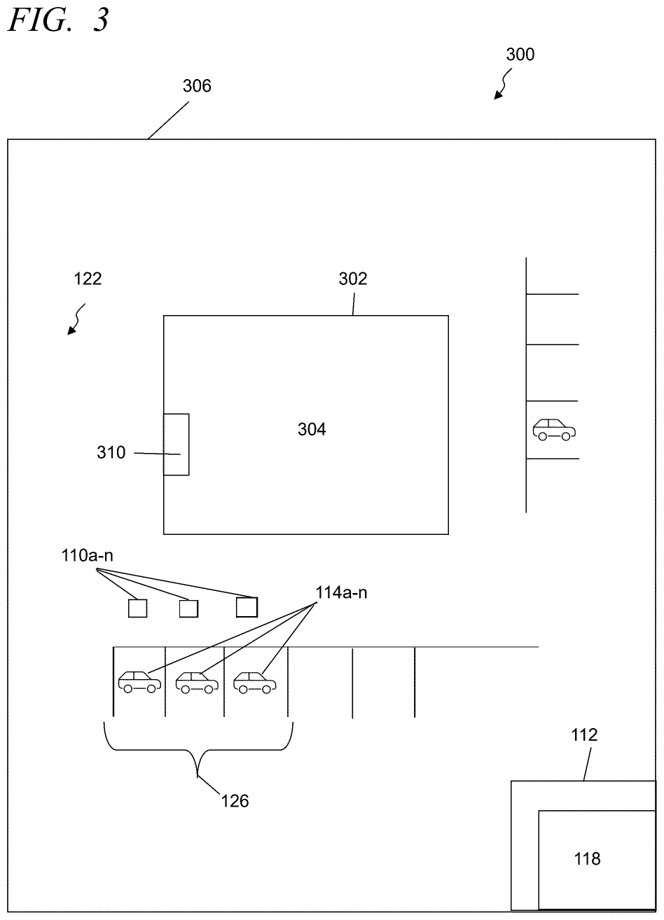

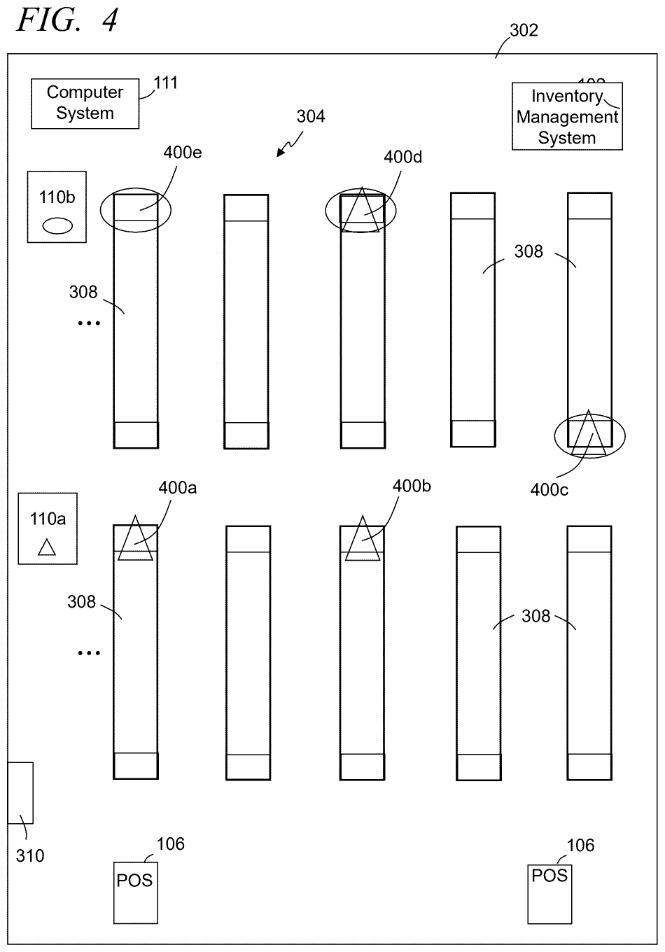

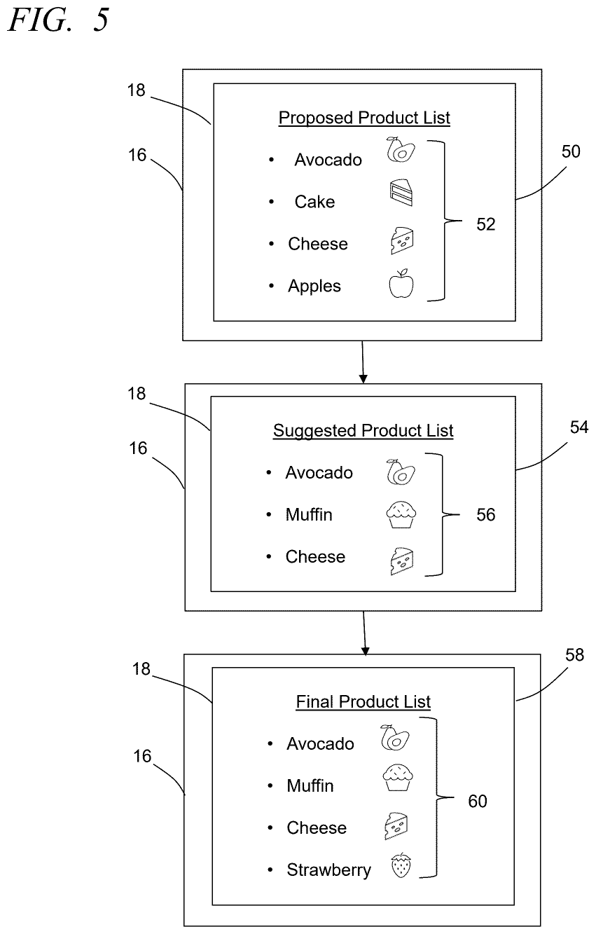

FIG. 3 is an illustration of a retail store system 300 having a “brick and mortar” retail store 302 and surrounding the retail store site or geographic perimeter 306. The retail store system 300 utilizes the systems and methods, such as the product retrieval system 100, and its devices and methods described herein, in order to retrieve, accept payment, and deliver products to customers, in accordance with some embodiments. A geographic perimeter 306 bounds the site or external area 122 outside of the retail store 302. The retail store system 300 has one or more parking lots, drive thru, or walk-in customer site entrances 118 at one or more locations along the geographic perimeter 306. The retail store entrance 310 is the location through which a concierge, walk-in customer, shopper, unmanned vehicles 116 may enter the internal product storage area 304 within the retail store 302.

The system 300 may also include an optional sensing system 112 having one or more sensors. As noted above, the sensing system 112 may be coupled to a sensor 26 of the mobile device 110. Components of the sensing system 112 may be provided at or distributed around the geographic perimeter 306 or the site entrance 118 or other portion of the geographic perimeter 306. The one or more sensing systems 112 can be communicatively coupled with the computer system 111, the mobile devices 110 and/or other components of the system 100. In some embodiments, the sensor data from one or more sensor systems 112 is used, such as by the computer system 111, the mobile device and/or other components of the system 100 to determine a number of details regarding at least arriving customers including, but not limited to: arrival time, location of the plurality of customers, vehicle type, retail store membership status, or other customer identifying information. Customers 114, according to some of the embodiments herein, may park or wait in a designated area 126, having a plurality of spaces, one for each customer, external area 122 outside of the retail store 302. Each space in the designated area 126 may be associated with one or more mobile devices 110a-n, or one or more customers 114a-n and/or customer vehicles associated with the customers 114a-n.

FIG. 4 is an illustration of a retail store 302 and exemplary shopping routes of two different customers 114a and 114b. In this embodiment, two different mobile devices 110a and 110b are used by two different store concierges to execute a shopping trip of the two different customers 114a and 114b respectively. As illustrated, the retail store 302 includes a computer system 111, and one or more point of sale systems 106 within the retail store 302. The aforementioned components are communicatively coupled over a communication network 108 along with the inventory management system 102. The retail store 302 includes a number of inventory storage compartments 308 (e.g., shelves, modules, containers, aisles, pods) for housing or storing products. The inventory storage compartments 308 may have a number of product pickup points 400a-e, which may be coupled to the storage compartments 308. Alternatively, product pickup points 400a-e may be distributed throughout the store near or at the location of the storage compartments 308 associated with a given product. In general, the shopping route of a customer 114 may be determined initially based on a shopping list, proposed product list 50 and/or suggested product list 54, and a product placement information within an inventory database within the inventory management system 102, and in some implementations additionally stored locally in memory 12 on a mobile device 110.

In FIG. 4, the store concierges respectively associated with the mobile devices 110a and 110b both enter the retail store 302 though the entrance 310. The products on the shopping list for customer 114a are located at four stops, namely pickup points 400a, 400b, 400c and 400d. The products on the shopping list for customer 114b are located at three stops, namely a shopping route that includes pickup points 400e, 400d and 400c. In this exemplary embodiment, a duration of the shopping route of customer 114a has four stops and may be reduced to fewer than four stops using the devices and methods herein. For example, the systems herein may reduce the shopping route for customer 114a by having the concierge retrieving products for customer 114b delivering products for customer 114a located at a common pickup point 400d with customer 114b to another common product pickup point 400c, expected crossing location where concierges are expected to be within a threshold distance, and/or at one of one or more general pickup points (e.g., proximate one or more entrances 310). Accordingly, a duration of the shopping route for the products for customer 114a is reduced by at least the time it would have taken the concierge for customer 114a to retrieve products at product pickup point 400d. Essentially, the shopping route for customer 114a may be updated to consist of only three stops, rather than the initial four, and similarly the shopping list or product list is adjusted to increase a number of the product at common pickup point 400d to be retrieved and identifying drop-off location information designated for that additional product without substantially increasing the shopping trip duration of customer 114b.

In adjusting and/or reducing the duration of the shopping routes as described above, mobile devices 110a and 110b communicate information about their respective shopping trips to one another and/or the computer system 111, and the system 100 optimizes the routes, lists and/or durations based on, for example, location of the product pickup points 400, product amounts, start time of the respective trips, expected end times of respective trips, request for urgent or prioritized shopping by one or more customers 114, and/or other such factors. In some embodiments, the mobile devices 110 and/or the computer system 111 evaluates shopping lists, proposed product list 50, a suggested product list 54 and/or other relevant product lists of multiple customers to be collected where at least some of the duration in collected those products for those different customers is predicted to overlap. Some embodiments further calculate expected times of travel of the routes to different products to be collected. Based on location information of products and/or the mobile devices 110, the one or more mobile devices and/or the computer system 111 identify common pickup locations 400 and subsequent common locations, crossing locations and/or common general drop-off locations. Using this information, the one or more mobile devices 110 and/or computer system 111 adjust the respective shopping list, proposed product list 50 and/or suggested product list 54 in order to enable a cooperative product retrieval by two or more concierges and/or store associates to improve the collection of products. It is noted that in some instances, a second concierge may not be scheduled to collect a product at a collection point 400 of a product for a different customer, but instead is expected to pass the collection point while retrieving a separate product for another customer at a different collection point. Accordingly, the routing and/or product retrieval list for two or more concierges may be adjusted based on the expected route of different concierges. Similarly, routing and/or product pickup lists for one or more concierges may be adjusted over time (e.g., based on a new customer requesting a product that may be along a route of another concierge that is already in the process of retrieving products and expected to at least pass a collection route for a product requested by the new customer).

In some embodiments, the routes and lists associated with different concierges and/or customers are continuously monitored in attempts to identify common products and/or routes that enable the cooperative retrieval of products for multiple customers by multiple concierges. Additionally or alternatively, in some embodiments, further concierges and/or other store associates may operate as pickers and not directly interface with a specific customer. These concierge pickers are instructed, through their respective mobile device 110, to collect products for one or more customers that are being helped by another concierge and provide those picked products to an identified common point 400, another concierge and/or general pickup location for retrieval by one of the other concierges in filling a shopping list. While the aforementioned adjustment and/or reduction of the shopping trip duration is illustrated with respect to two customers 114a-b in the foregoing exemplary embodiment, it can be understood that the systems and methods herein may be used to incorporate multiple customers, their related information etc., in order to reduce and/or minimize the duration of one or a plurality of customer shopping trips.

FIG. 5 is an illustration of the display 18 of the user interface 16 of a mobile device 110. Three different exemplary lists are displayed, namely, at least a portion of an exemplary proposed product list 50, at least a portion of a suggested product list 54, and at least a portion of a final product list 58, in accordance with some embodiments. The proposed product list 50 may have one or more products 52 which may be retrieved by a concierge associated with a mobile device 110 and may be determined based on a customer's 114 prior shopping history. In an embodiment, the proposed product list 50 is received through a mobile device 110 associated with the retail store 302. Additionally or alternatively, the proposed product list 50 may be received in part or directly from a respective customer 114 when the customer 114 arrives at the retail store 302. In an embodiment, the proposed product list 50 is obtained by a customer 114 providing some or all of the information directly to the concierge by one or more of: verbally telling the concierge a list of products; showing the concierge a written list that the concierge manually enters; using a camera of the mobile device 110 to take a picture of a written list; using image processing and/or text recognition features of the mobile device to automatically generate a preliminary proposed product list 50 that can be verified and/or modified; receiving some or all of the proposed product list 50 by electronic communication from a customer's device (e.g., computer, smartphone, laptop, tablet, etc.); and accessing within a customer profile a previously populated shopping list (which may include one or more products automatically scheduled to be purchased (e.g., customer scheduled), etc.

In some embodiments, a suggested product list 54 is determined based on a proposed product list 50 and one or more variables and a weighted average of a plurality of variables. When the concierge (e.g., associate) selects on item from the suggested product list 54, weighted items may be highlighted (e.g., in red on the display 18) until they are scanned, giving the associate the indicator that the items are accounted for. Such variables may include, for example, an average consumption rate of items purchased by the relevant customer within a predetermined time period; a ratio of a visit frequency and a product consumption rate; a visit frequency; a total product sales within a second predetermined time period, a product freshness indicator; a number of days since the relevant customer last purchased at least one product on the proposed product list; a frequency of visits to the retail store 302; a total number of visits from other customers who purchased at least one item on the proposed product list; and a total number of distinct customers who purchased at least one product on the proposed product list. The foregoing examples are intended to be illustrative and are not intended to convey an exhaustive listing of all possible variables. Instead, it will be understood that these teachings will accommodate other variables relative to inventory, customer preferences, purchase history, and the like.

In an embodiment, the suggested product list 54 is determined by: inputting data from a primary customer profile of the relevant customer 114; calculating the weighted average of the plurality of variables; and applying a set of product filtering rules (e.g., customer budget, product sale status, expected inventory deliveries) that restrict inclusion and/or display of available products based on the current inventory obtained from the inventory management system 102 and/or locally stored on the mobile device 110, a calculation of the weighted average of the plurality of variables and/or other filtering. The suggested product list 54 is based on the proposed product list 50 and supplemented with removal or addition of other products based on inventory availability or other factors (e.g., sale price, coupon usage, up-sale proposals). Additionally or alternatively, the suggested product list 54 may be changed based on additional requests or changes made by the customer 114 during the shopping trip.

A final product list 58 is the actual list of products 60 that are purchased and delivered to a customer 114. The products 60 on the final product list 58 may be identical to the products 52 on the proposed list 50 or the products 56 on the suggested product list 54. Alternatively, the final product list 58 may have an increased number of products 60, or different brands of products relative to the other lists 50, 54. Moreover, the final product list 58 may also include products 60 that were neither on the proposed product list 50 nor on the suggested product list 54. For example, a customer 114 may communicate with the mobile device 110 during the shopping trip that an additional, previously forgotten, item is requested. In an embodiment, one or more of the plurality of mobile devices 110 are configured to update the products 56 on the suggested product list 54 by communicating with the relevant customer 114 located outside of the retail store 302 to confirm and then determine the products 60 for purchase on the final product list 58.

In order to confirm the final product list 58, a concierge or store associate may identify a related product on sale and communicate with the customer 114 to determine whether the customer 114 would prefer the on-sale product. Additionally or alternatively, the concierge may contact the customer 114 via the mobile device 110, in an instance where inventory information about one or more was not accurate, or otherwise changed after the time of obtaining the proposed or suggested product lists 50, 54. Additionally or alternatively, a concierge may notify customer of delays and whether to exclude a product causing the delay etc. Communication between a concierge and a customer 14 may be achieved for example, directly from the concierge mobile device 110 and a mobile device associated with the customer; between two mobile devices 110; between the customer 114 and a personal mobile device 110n that is not associated with the initial concierge (e.g., a different concierge that speaks with the customer; etc.).

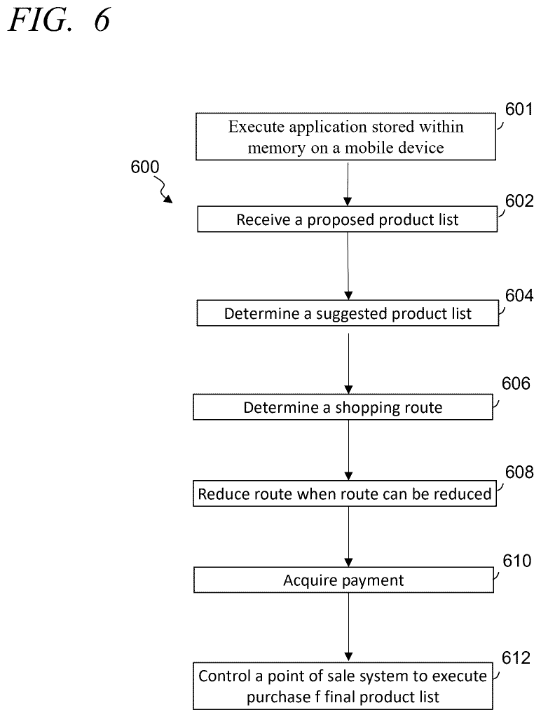

FIG. 6 is a flow chart of an exemplary method 600 of executing the purchase of products on a final product list 58 using a mobile device 110 and a device control circuit 6, in accordance with some embodiments. The method 600 includes executing 601, an application 3 stored within memory 12 on a mobile device 110 for performing the steps of the method 600. The method 600 further includes receiving 602 a proposed product list 50 from a customer 114. The method 600 also includes determining 604 a suggested product list 54. Then, the method 600 includes the step of determining 606 a shopping route. The method 600 further includes reducing 608 a shopping route when a shopping route can be reduced. The method 600 further includes a step of acquiring 610 a payment from a customer 114. The method 600 further includes controlling 612 a point of sale system 106 to execute purchase of products on a final product list 58.

Customer payment may be obtained, for example, by a customer 114 physically providing a payment method when arriving at the store 302, using a payment method previously stored in customer profile, and/or using a payment method provided during, prior to or after the final product list 58 is determined. Some embodiments, for example, enable a customer to log-in to a customer account. The log-in may be further secured through multi-factor and/or multi-method authentication of the customer (e.g., through a response to a predefined email address associated with the customer, through a response to a text message to a mobile device associated with the customer, through one or more passwords, through one or more biometrics (e.g., confirmation of a known finger print, palm print, retinal scan, other such biometrics or a combination of two or more of such biometrics), through correctly answering one or more predefined questions, other such authentications or a combination of two or more of such authentications. In some embodiments, the mobile devices 110 and/or the concierge application enables the mobile device on which it operates to receive credit card information, gift card information and/or other such payment method information, and use that to receive payment for some or all of the products. The credit card information, gift card information, and/or other such card information, in some implementations, is acquired through a manual entry of a card number and/or other identifier, image processing of a card number or barcode of the card corresponding to a card number or identifier, detected through a microchip scanner (e.g., executed through the mobile device 110, the APP 3, a separate scanner, etc.) scanning magnetic strip and/or a microchip embedded within the card, other such methods or a combination of two or more of such methods. Alternatively or additionally, in some embodiments, the card scanning system is a magnetic strip reader and/or chip-reader hardware system that externally cooperates with the mobile device 110 (e.g., through a USB interface, USB-C interface, lightning interface, and/or other such coupling interface) that captures the card information. Further, in some implementations, some or all of the card information is captured in an encrypted format and maintained in an encrypted format when transferred from the mobile device 110 in acquiring payment, and/or the scanning system, whether internal to the mobile device or externally cooperated with the mobile device encrypts and/or encodes some or all of the card information prior to communicating the card information in acquiring payment. Still further, the system in some embodiments typically prevents some or all of the card information from being locally stored on the mobile device 110, and/or is prevented from being locally stored without the card information being protected (e.g., encrypted, encoded, etc.).

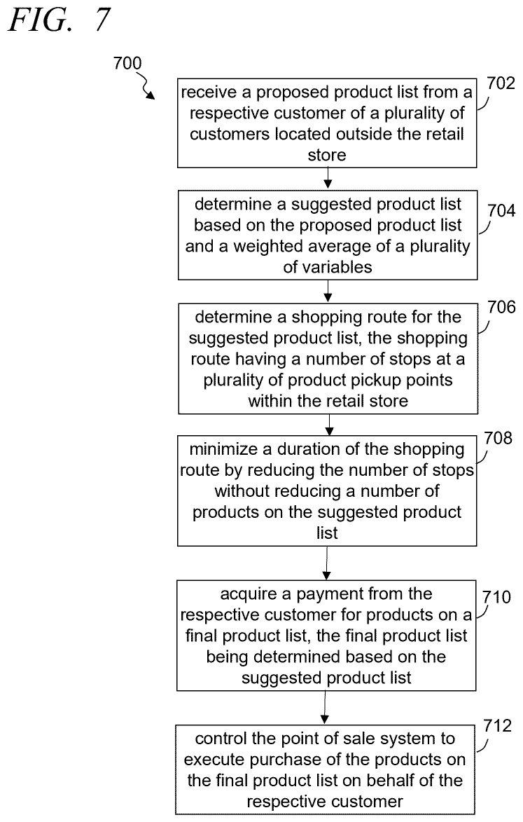

FIG. 7 is another exemplary method 700 of executing the purchase of products using the system and devices herein, in accordance with some embodiments. The method 700 for providing retrieval of products within a retail store 302 includes a plurality of steps comprising, receiving 702 a proposed product list 50 from a customer 114 located in a vehicle at the retail store 302 and outside of the retail store 302. The method 700 also includes determining 704 a suggested product list 54 based on the proposed product list 50, variables and one or more weighted averages of two or more of a plurality of variables. In some embodiments, the suggested product list 54 comprises a listing of one or more products intended to be purchased by the customer 114 before leaving the retail store 302. The method 700 further includes determining 706 one or more shopping routes that one or more concierges are to follow and each shopping route having a number of stops at one or more product pickup points 400 within a retail store 302. The method 700 further includes, in some embodiments, an optional step of minimizing 708 a duration of the shopping route by reducing the number of stops without reducing a number of products on the suggested product list 54. The method 700 further includes acquiring 710 payment information from the customer 114 for products on a final product list 58, the final product list 58 being determined based on the suggested product list 54. The method 700 further includes controlling 712 a point of sale system 106 to execute a purchase of the products 60 on the final product list 58 on behalf of the customer 114.

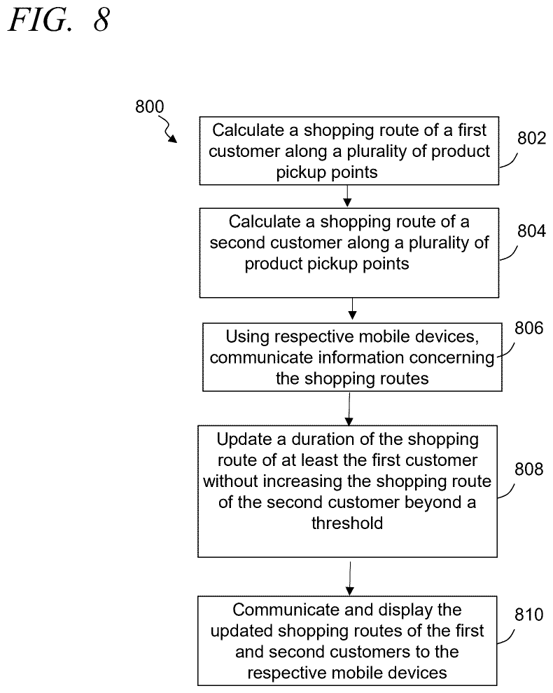

FIG. 8 is an exemplary method 800 of minimizing or reducing the duration of the shopping route of at least one customer at a retail store 302, in accordance with some embodiments. In general, a duration of a shopping route of a customer 114 may be minimized by updating the shopping route of a first customer 114a by coordinating retrieval of one or more products along a shopping route of a second customer 114b. In an embodiment, the method 800 includes calculating 802 a shopping route of a first customer 114a along a plurality of product pickup points 400. The method 800 further includes calculating 804 a shopping route of a second customer 114b along a plurality of product pickup points 400. The method 800 also includes, using respective mobile devices 110a-b designated for the first customer 114a and the second customer 114b, communicating 806, and exchanging as needed, information concerning the shopping routes of the first and the second customer 114a-b. Such information may be, for example, the product lists, location of the product pickup points 400, product amounts, start time of the respective shopping trips, and/or customer requests for urgent or prioritized shopping, if any.

The method 800 further includes the step of updating 808 a duration of the shopping route of at least the first customer 114a. In an embodiment, this step may be performed without increasing the shopping route of the second customer 114b by more than one or more thresholds. The amount of increase may be set relative to a predetermined or pre-selected threshold time. Alternatively or additionally, the threshold may be set relative to a status of the customer shopping trip as being designated as urgent. In an embodiment, a customer 114 may be charged an increase at the point of sale system 106 for the final product list 58 based on such an urgent shopping trip designation. The method 800 further includes the steps of communicating 810 and displaying the updated shopping routes and/or updated product lists of the first and second customers 114a-b to the respective mobile devices 110a-b.

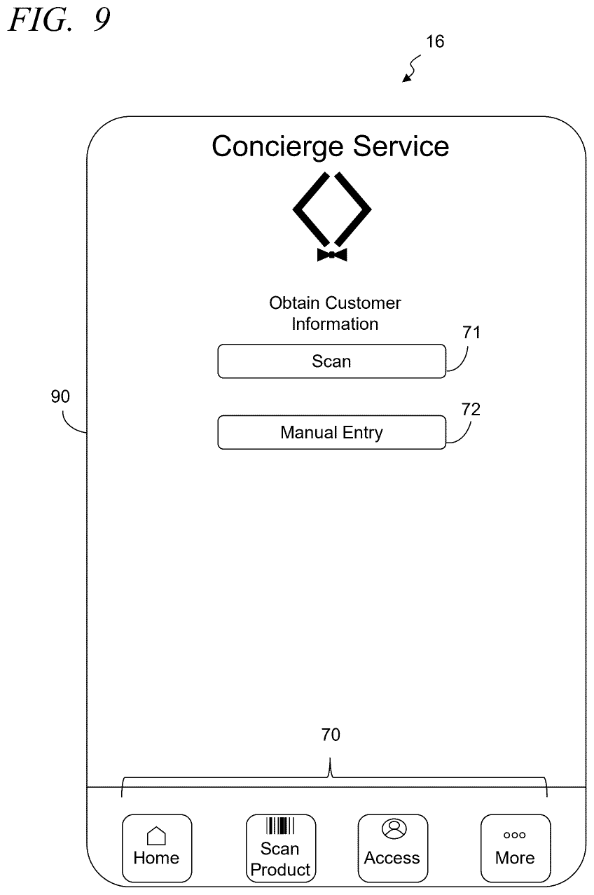

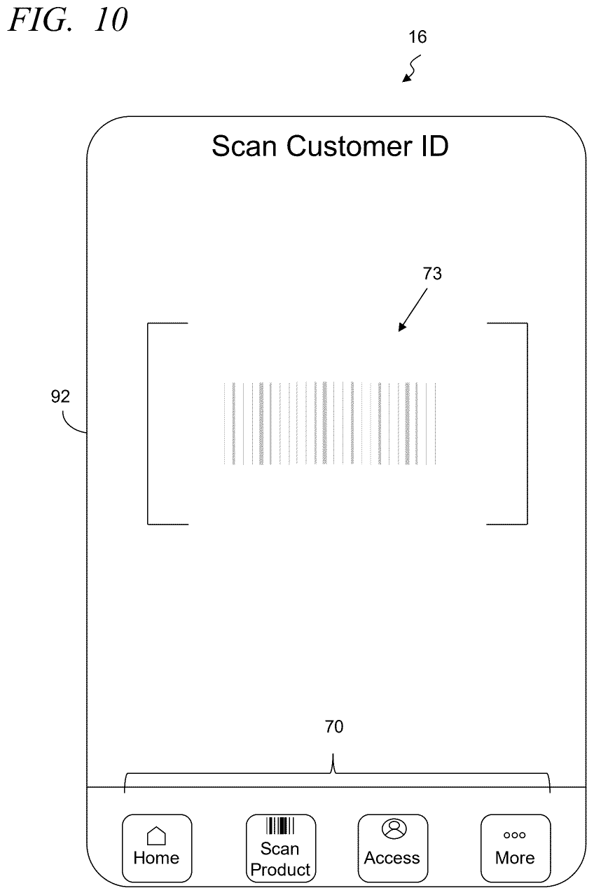

FIGS. 9-12 are illustrations of a plurality of exemplary views 90, 92, 94, 96 of presented on a display 18 of the user interface 16 (e.g., graphical user interface) of a mobile device 110 for performing some of the steps of the methods of performing product retrieval, in accordance with some embodiments herein. In some embodiments, the views 90, 92, 94, 96 may be generated by a processor 14 within a mobile device 110 executing one or more applications 3 and operate on a touch enabled instruction execution protocol coupled to depressing portions of the images on the display 18 of the user interface 16. FIG. 9 is a first view 90 for obtaining data related to customer information or identification. For example, by tapping or depressing a desired selection on the user interface 16 of a mobile device 110, a user may execute certain instructions of one or more steps of the method(s) herein. In one embodiment, a user may enter customer identifying data by selecting scan 71 or manual entry 72. The first view 90 may also include a plurality of application selection menus 70. The menus 70 may include, home, scan product, access and more functions related to the methods for product retrieval according to the embodiments herein. FIG. 10 is a second view 92 of the aforementioned scanning function 73 of a mobile device 110. If scan 71 was selected in the view 90 of FIG. 9, the scanning function 73 of FIG. 10 may appear and may be used to scan a customer's identifying information (e.g., in the form of a bar code or QR code). The information may be, for example, retrieved from a customer's government or bank issued ID, retail store membership card, or other identifying data associated with a customer 114 or customer's account (e.g., using a camera of the mobile device and image processing, manual entry of information from the ID, detecting a code, etc.). In the embodiment of the second view 92 illustrated in FIG. 10, an ID of the customer 114 in the form of a bar code is scanned.

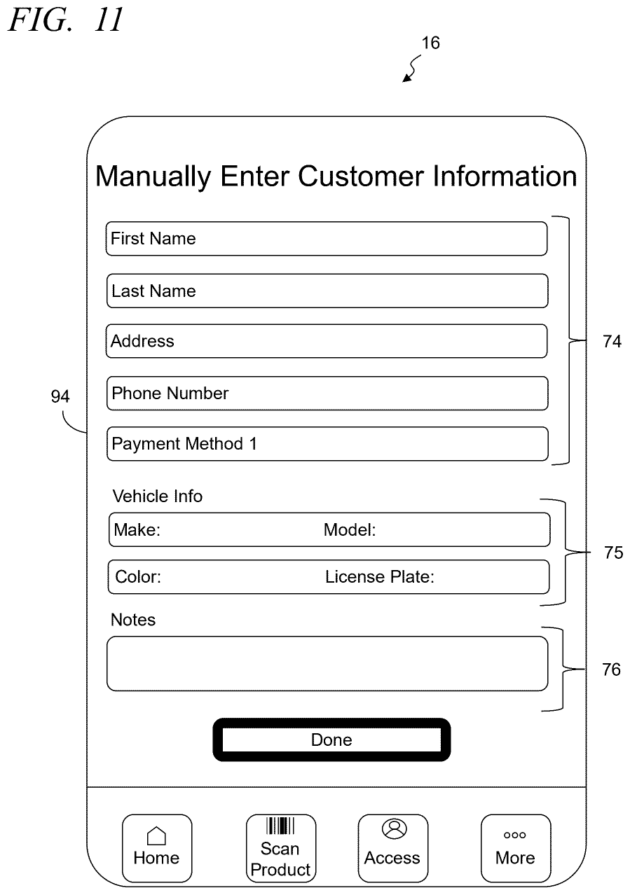

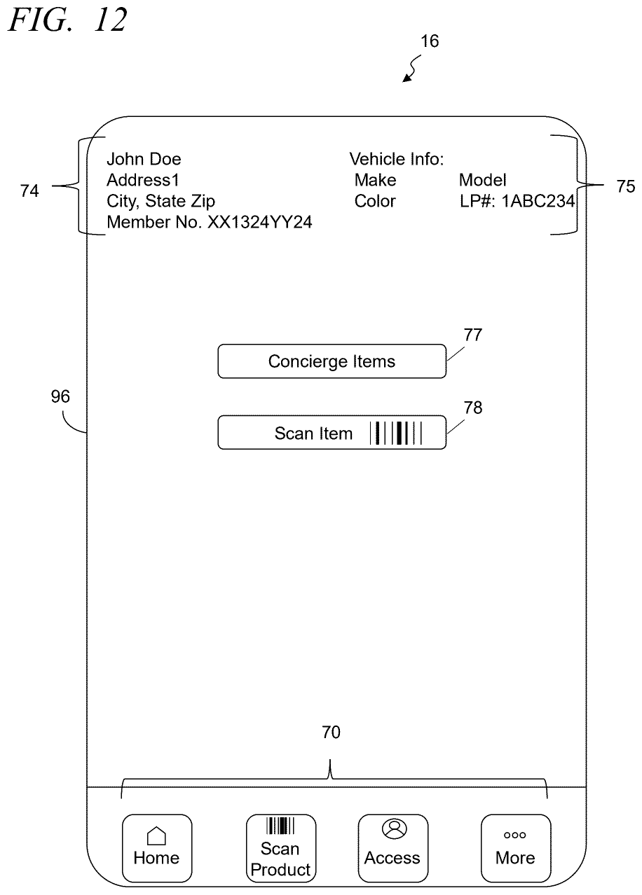

If manual entry 72 is selected in FIG. 9, a third view 94 illustrated in FIG. 11 appears for capturing capture of costumer information. The information that may be retrieved may include, for example: biographical/personal information 74 (e.g., first name and last name, address, phone number, payment method) and/or vehicle information 75 (e.g., make, model, color, license plate). The third view 94 further illustrates that additional notes 76 related to the customer 114 may be input into the system 100 via the user interface 16. In the fourth view 96 illustrated in FIG. 12, all or a portion of the customer information (e.g., biographical/personal 74 and/or vehicle 75) obtained in FIG. 11 may be provided in a fourth view 96. In addition, a user may also be prompted to view a list of concierge items 77, which may include one or more of the proposed 50, suggested 54, final 58 product lists or updates of any of the foregoing as previously described. The user may also access a scan items function 78 in the fourth view 96.

In some embodiments, a concierge application (APP) 3, stored within memory 12 is executed on each of the mobile devices 110. The application 3, as provided for example in FIG. 2, when executed by a device control circuit 6 within each of the mobile devices 110, in some embodiments, causes the device control circuit to communicatively interface with one or more of inventory management system 102, customer database 104, point of sale systems 106, sensing systems and/or other devices, and process information to support the retrieval of products on behalf of the customer. The APP 3 can provide a customized product option in obtaining product identifying information of products that the customer intends to purchase. In some embodiments, the customized product option utilizes the identity of the customer to access purchase history information and/or customer profile information. The APP 3 applies filters based on the purchase history, preferences, timing information, and other such information to filter the available products and provide a customized limited listing of products to be presented to the customer for selection in compiling the proposed product list 50 and/or the suggested product list 54. In some embodiments, the APP 3 further provides an additional “concierge” option that provides an increased number of products that are presented to the customer. This increased number may be all of the products available through the retail store, or a limited or filtered set of products that are available through the concierge service. Some products may be designated as not available through concierge service, and these are filtered out from the concierge listing of products available (e.g., such televisions and other electronics, products exceeding a threshold price, products exceeding a threshold size and/or weight, etc.). The APP 3, in some embodiments, is restricted to store owned devices. In other instances, the APP 3 requires log-in by the worker prior to activation to enhance security and/or limit use to authorized users.

In some embodiments, the product retrieval system 100 and methods enables concierge store associates and/or unmanned vehicles at a retail store to interact with a customer while the customer remains in their vehicle at the store location. The concierge or unmanned vehicle receives from the customer the identifying information of the products the customer is interested in purchasing at that time. In some embodiments, a concierge APP 3 implemented on a mobile device 110 and/or implemented within the unmanned vehicle enables the electronical collection and/or virtually select of products the customer intends to purchase and take home. These products can be added to a suggested shopping list and/or added to a preliminary virtual cart. The suggested shopping list is used by one or more concierge associates and/or one or more unmanned vehicles at the retail store to collect the products locally at the retail store on behalf of the customer so that the customer does not have to enter the store or leave their vehicle. Similarly, the shopping can be completed without the customer having to touch the products and/or the concierge. Once the products are collected at the retail store while the customer waits outside of the store, a purchase is completed by receiving payment from the customer, or through an authorization to access a payment method maintained in a customer profile by the retail store (typically, after authenticating the customer), and the products are loaded into the customer's vehicle without the customer having to leave their vehicle. In some embodiments, the APP 3 enables the concierge associate to associate the portable device with a particular retail store (e.g., though scanning an identifier of the retail store (e.g., bar code, RFID tag, identifier number and/or other ID, or other such information), an address, a zip code, other such information or a combination of such information).

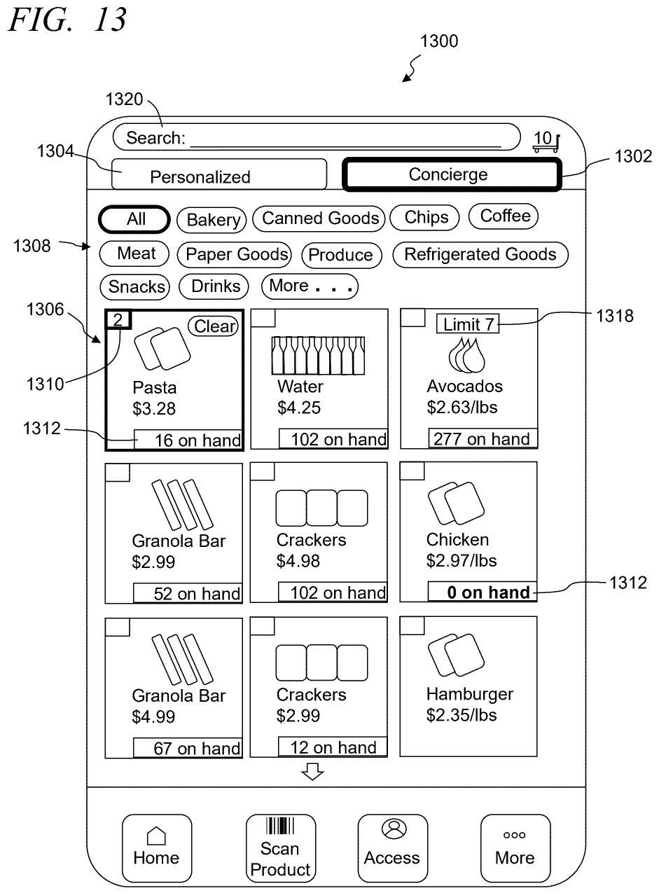

FIG. 13 illustrates a simplified representation of an exemplary graphical user interface 1300 to enable concierge selection of products to be incorporated into the suggested product list, in accordance with some embodiments. In this example, a concierge option 1302 is selected limiting the number of presented products 1306 based on products available through the concierge service. Some embodiments include a personalization option 1304 that further filters products to those more likely to be purchased by the identified customer based on purchase history and/or other such factors. The concierge application, in some implementations, provides product category options 1308 that focus presented products 1306 based on a selected category. In some embodiments, the presented products 1306 further enable the selection of one or more products, which may be showed through highlighting or other such indication. A quantity 1310 of the selected product intended to be purchased is displayed in some implementations. In some embodiments, the presented products 1306 further identify an available quantity 1312 of that product available according to current inventory information, when such quantity information is known. This can include identifying when inventory is out of stock and/or identifying a “0” on hand. Such information enables a concierge to notify a customer in real time of the availability of a product. Some embodiments further identify when there is a quantity limit 1318, which restricts the purchase at the designated price to the quantity limit and/or allows the concierge to inform the customer in real time of the limit. Still further, some embodiments include a search field 1320 or option that allows the concierge to perform a search for a particular product the customer is interested in purchasing. The search, in some implementations, does not wait for a completion of entry of a search term, and instead attempts to auto-populate as the user enters the search term allowing more rapid entry. Similarly, the search can initiate prior to fully receiving the search term, and the search can filter products based on the partial entry.

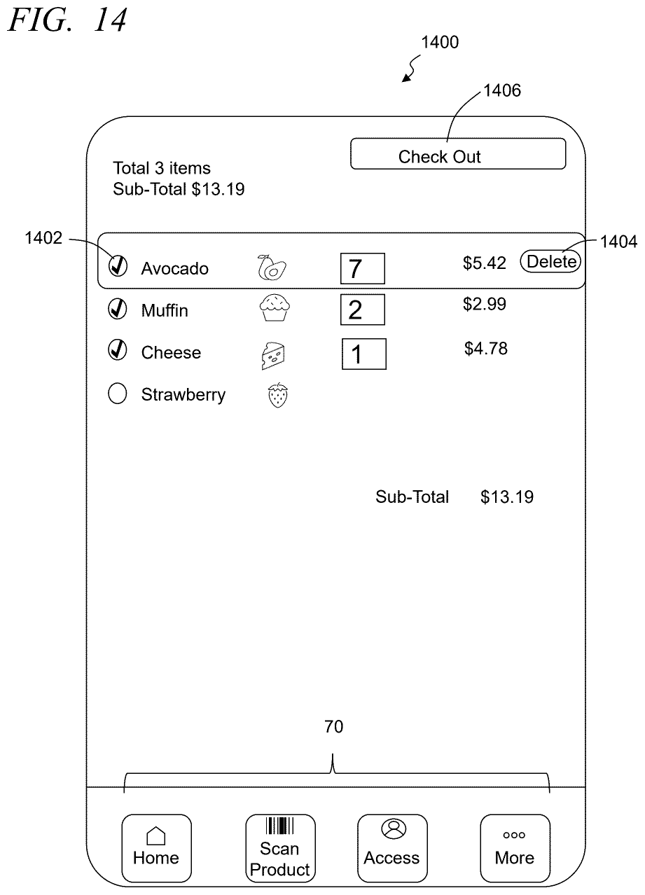

FIG. 14 illustrates a simplified representation of an exemplary summary product list graphical user interface 1400 that enables a concierge to confirm when a product in the summary product list is retrieved, in accordance with some embodiments. In some embodiments, a concierge selects retrieve indication 1402 when the product from the list is retrieved and/or multiple products are retrieved. In other implementations, the retrieved indication is automatically activated in response to the concierge scanning the appropriate quantity of a product. The scanning may be through barcode scanning, RFID scanning, image recognition, text scanning and/or other such scanning. For example, in some embodiments products are identified in accordance with the systems and methods described in U.S. patent application Ser. Nos. 16/800,290 and 16/800,370, which are incorporated herein by reference in their entirety. Some embodiments further include pricing information and/or a sub-total may be provided. Still further, in some implementations, the summary product listing graphical user interface 1400 and/or the information from this summary product listing graphical user interface is communicated to a customer mobile device executing a customer application to display the information and enable the customer to see the progress of the collection of products. In some embodiments, a delete option 1404 is provided to enable the concierge associate to remove a product, such as when an incorrect product is retrieved and/or scanned, the customer requests the product be removed, and/or other such factors. The summary product list graphical user interface 1400, in some embodiments, includes a check-out option 1406 to cause the purchase of the retrieved products.

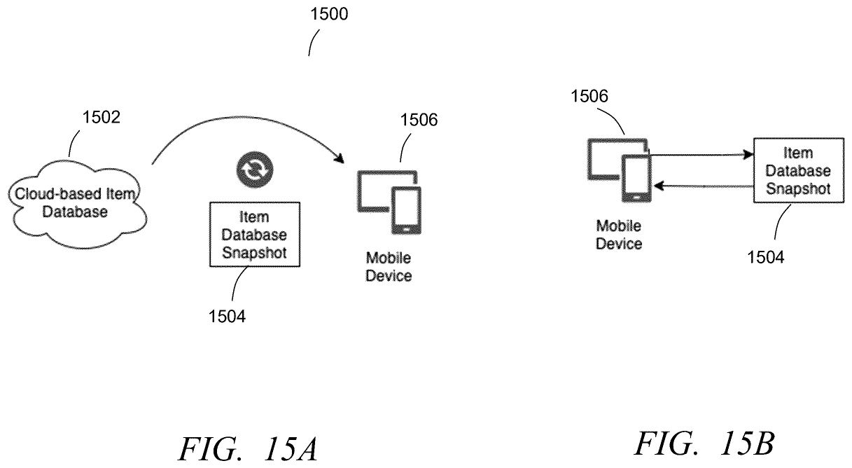

FIGS. 15A-15B show a simplified illustration of a computer-based system 1500 for retrieving products from within a retail store. The system 1500 is designed to synchronize digital product information stored in a cloud-based item database 1502 to one or more mobile devices 1506 to allow such product information to be available, even in the event of the mobile device 1506 losing connectivity with a network (e.g., the internet). An item database snapshot 1504 at a given point in time is synchronized to an application 3 deployed on the mobile device 1506 while the mobile device 1506 has connectivity to the network. Once the synchronization is complete, the APP 3 executed on the mobile device 1506 uses the snapshot 1504 to retrieve product information rather than the actual item database 1502 (e.g., cloud-based item database). The synchronization process happens as changes to the actual item database 1502 are detected, provided that the mobile device 1506 is in communication over one or more networks with the item database and/or the inventory management system 102, such as has internet connectivity, wireless local area network (LAN) connectivity, etc.

The system improves the performance and operation of at least the mobile devices, in part, by reducing information to be processed and improving performance. In some embodiments, the control circuit 6 applies filtering to the inventory information based on the one or more variables (e.g., customer purchase history, product demand, inventory quantities, inventory limits, customer priority, membership level, products orders by other customers, other such variables, or a combination of two or more of such variables) and/or weightings to limit the products to be processes by the mobile device to a sub-set of products that are displayed and/or presented as potential products based on an identifier of a product from the proposed product list. This sub-set of products further improves performance by reducing products from which the worker can select a particular one of those sub-set of displayed products to be included in the final product list. In some embodiments, the variables are accessed from a customer profile associated with the customer. One or more variables can be selected from this listing and applied based on filtering rules to filter the current inventory information and obtain a filtered listing of product information specific to the customer, which may further be consistent with the purchase history of the customer. Some embodiments additionally or alternatively improve the system by applying the same or similar variables and/or weightings in restricting searching for potential products from the products identified in the customer proposed product list to the filtered listing (e.g., apply a set of one or more product filtering rules and filtering the filtered listing of products to identify a suggested listing of one or more suggested products that are predicted to correspond to the proposed product list).

The control circuit, in some embodiments, is configured to control and/or a central control system communicatively coupled with the mobile device is configured to control the display of the mobile device and/or one or more external display (e.g., within the retail facility and along an intended route) to display an interactive GUI to enable the worker to identify products from the potential product list to be added to the final product list, display routing, display updated routing based on retrieval of one or more products acquired by another worker (e.g., a central control system can be configured to track product retrieval by one or more workers and update the product list as products are retrieved and/or modify routing based on products retrieved when relevant), display products from the product list, to be retrieved, identify in a product list of products already retrieved by one or more workers, display alternative products, other such information and/or a combination of such information. In some embodiments, the GUI further enables the worker to access other functionality such as but not limited to payment options, search inventory, request help, submit a request that another worker and/or autonomous system and/or vehicle, to retrieve one or more products, control one or more autonomous systems and/or vehicles, other such control, or a combination of such actions.

Some embodiments include a central control system comprising one or more central control processors and/or circuits that cooperatively operate over the distributed network 108 and wireless communicate with the mobile devices, receives location information of the mobile devices, determines routing (based on location of the mobile device and products in the final list that have yet to be retrieved) and communicates the routing to the mobile device to control the mobile device to display at least a portion of the routing, and/or repeatedly updating the routing and controlling the mobile device to display the updated routing (e.g., based on a subset of products being retrieved by another worker, a subset of products not being retrieved by another worker, inventory information (e.g., identify inventory is now zero based on point-of-sale data for other customers), other such information, or a combination of two or more of such information), and other such control over the mobile devices. Similarly, in some embodiments, the central control system provides at least some control over display systems and/or cameras in the retail facility to provide feedback to the system in tracking the workers' movements in retrieving products for customers, tracking inventory and controlling the restocking of shelves, tracking autonomous systems, controlling autonomous systems, other such control, or a combination of two or more of such actions and/or controls.

Some embodiments provide a system improving the retrieval of products within a retail facility comprising: an inventory management system of a retail store; a customer database storing customer profiles for hundreds of different customers that have previously purchased products from one or more of multiple different retail stores including the retail store; point of sale systems at the retail store, wherein the point of sale systems are configured to identify products intended to be purchased, obtain pricing for each of the identified products, and obtain payment from a relevant customer purchasing each identified product, wherein the point of sale systems are communicatively coupled over a communication network with the inventory management system, wherein the inventory management system is configured to receive purchase information of each product purchased from the retail store through one of the point of sale systems and continuously maintain a current inventory of each product offered for sale from the retail store based at least on the purchase information and product shipments received at the retail store; a plurality of mobile devices in wirelessly communication with the inventory management system and the customer database, wherein each of the plurality of mobile devices comprises a device control circuit configured to: receive a proposed product list from a respective customer of a plurality of customers located outside the retail store; determine a suggested product list based on the proposed product list and a weighted average of a plurality of variables; determine a shopping route for the suggested product list, the shopping route having a number of stops at a plurality of product pickup points within the retail store; minimize a duration of the shopping route by reducing the number of stops without reducing a number of products on the suggested product list; acquire a payment from the respective customer for products on a final product list, the final product list being determined based on the suggested product list; and control the point of sale system to execute purchase of the products on the final product list on behalf of the respective customer.

In some embodiments, a system providing retrieval of products within a retail store comprises: an inventory management system of a retail store, the inventory management system configured to continuously maintain a current inventory of each product offered for sale by the retail store; a customer database storing a plurality of primary customer accounts of different customers that have previously purchased products from one or more of multiple different retail stores including the retail store; a point of sale system at the retail store communicatively coupled over a communication network with the inventory management system; and a plurality of mobile devices configured to wirelessly communicate with the inventory management system and the customer database. Each of the plurality of mobile devices comprises a device control circuit. An application is deployed on each of the plurality of mobile devices. The execution of the application through a respective device control circuit on each of the plurality of mobile devices causes the device control circuit to: receive a proposed product list from a respective customer of a plurality of customers located outside the retail store; determine a suggested product list based on the proposed product list and a weighted average of a plurality of variables; determine a shopping route for the suggested product list, the shopping route having a number of stops at a plurality of product pickup points within the retail store; minimize a duration of the shopping route by reducing the number of stops without reducing a number of products on the suggested product list; acquire a payment from the respective customer for products on a final product list, the final product list being determined based on the suggested product list; and control the point of sale system to execute purchase of the products on the final product list on behalf of the respective customer. In some embodiments, the application when executed on the device control circuit of each of the plurality of mobile devices is configured to update the suggested product list by communicating with the relevant customer located outside of the retail store to confirm the final product list. The device control circuit, in some embodiments when executed the application, in determining the suggested product list is further configured to: input data from a primary customer profile of the relevant customer; calculate the weighted average of the plurality of variables; and apply a set of product filtering rules that restrict display of available products based on the current inventory obtained from the inventory management system and a calculation of the weighted average of the plurality of variables. In some implementations, the application when executed by the device control circuit is further configured to cause the device control circuit to identity the respective customer based on at least one of: a vehicle feature, a retail store membership card, a government issued ID, a bank card, and a personalized membership code issued by the retail store. The application when executed on the device control circuit, in some embodiments, is further configured to cause the device control circuit to receive a proposed product list of the respective customer without requiring a preestablished secondary electronic account of the respective customer.

In some embodiments, a method for providing retrieval of products within a retail store comprises: receiving a proposed product list from a customer located in a vehicle at the retail store and outside of the retail store; determining a suggested product list based on the proposed product list and a weighted average of a plurality of variables, wherein the suggested product list comprises a listing of one or more products intended to be purchased by the customer before leaving the retail store; determining a shopping route having a number of stops at a plurality of product pickup points within the retail store; minimizing a duration of the shopping route by reducing the number of stops without reducing a number of products on the suggested product list; acquiring payment information from the customer for products on a final product list the final product list being determined based on the suggested product list; and controlling a point of sale system to execute a purchase of the products on the final product list on behalf of the customer.

Some embodiments provide methods of providing retrieval of products for one or more customers within a retail store, comprising: receiving, by an application configured to be executed on a mobile device, a proposed product list from a customer located in a vehicle at the retail store and outside of the retail store; determining, by the application, a suggested product list based on the proposed product list and a weighted average of a plurality of variables, wherein the suggested product list comprises a listing of one or more products intended to be purchased by the customer before leaving the retail store; determining, by the application, a shopping route having a number of stops at a plurality of product pickup points within the retail store; minimizing, by the application, a duration of the shopping route by reducing the number of stops without reducing a number of products on the suggested product list; acquiring payment information from the customer, by the application, for products on a final product list, the final product list being determined based on the suggested product list; and controlling, by the application, a point of sale system to execute a purchase of the products on the final product list on behalf of the customer. The minimizing the duration of the shopping route, in some implementations, comprising updating the shopping route of the customer by coordinating retrieval of at least one product in the suggested product list comprising directing retrieval of the at least one product along with retrieval of one or more products of a shopping route of a second customer. In some embodiments, the method further comprises receiving, by the application, the proposed product list through a mobile device of a plurality of mobile devices associated with the retail store; and wherein the shopping route is determined based on product placement information within an inventory database. The method, in some embodiments, further comprising updating, by the application on at least one of the plurality of mobile devices, the suggested product list; and communicating, through a first mobile device of the plurality of mobile devices, while products identified in the suggested product list are being retrieved, a proposed modification to the suggested product list; and updating the suggested product list based on the proposed modification to obtain the final product list. Plurality of variables can include at least two of: an average consumption rate of items purchased by the relevant customer within a predetermined time period; a ratio of a visit frequency and a product consumption rate; a total product sales within a second predetermined time period, a product freshness indicator; a number of days since the relevant customer last purchased at least one product on the proposed product list; a frequency of visits to the retail store; a total number of visits from other customers who purchased at least one item on the proposed product list; and a total number of distinct customers who purchased the at least one product on the proposed product list.

In some embodiments, the determining the suggested product list comprises: inputting data from a primary customer profile of the relevant customer; calculating the weighted average of the plurality of variables; and applying a set of product filtering rules that restrict display of available products based on a current inventory obtained from an inventory management system and the weighted average of the plurality of variables. The method, in some embodiments, further comprises: determining by the application, based on sensor information from at least one sensing system, an arrival and a location of the plurality of customers in a predetermined proximity to the retail store. In some implementations, the method further comprises: maintaining a copy of a current inventory, from an inventory management system, in a local memory within each of a plurality of mobile devices; and updating, in response to detecting a loss of connectivity with the inventory management system, the copy of the current inventory list on each of the plurality of mobile devices when connectivity between the plurality of mobile devices and the communication network is regained. The method can further comprise obtaining, by the application, an identity of each of the plurality of customers by a respective one of the plurality of mobile devices based on at least one of: a vehicle feature, a retail store membership card, a government issued ID, a bank card, and a personalized membership code issued by the retail store. The receiving the proposed product list can comprise receiving the proposed product list of the respective customer without requiring a preestablished secondary electronic account of the respective customer. In some embodiments, the method further comprises causing, by the application, the products on the final product list to be delivered to the customer at the vehicle located outside of the retail store. The method, in some embodiments, further comprises activating an autonomous vehicle, by the application, communicatively coupled to the sensing system and at least one of the plurality of mobile devices, and communicating, by the application, routing instructions and product retrieval instructions to the autonomous vehicle and causing the autonomous vehicle to retrieve the products and deliver the products to the customer vehicle.

In some embodiments, an application for providing retrieval of products for one or more customers within a retail store, the application, when executed on a mobile device is configured to cause a device control circuit on the mobile device to: receive a proposed product list from a respective customer of a plurality of customers located outside the retail store; determine a suggested product list based on the proposed product list and a weighted average of a plurality of variables; determine a shopping route for the suggested product list, the shopping route having a number of stops at a plurality of product pickup points within the retail store; minimize a duration of the shopping route by reducing the number of stops without reducing a number of products on the suggested product list; acquire a payment from the respective customer for products on a final product list, the final product list being determined based on the suggested product list; and control the point of sale system to execute purchase of the products on the final product list on behalf of the respective customer.

The foregoing description is not to be taken in a limiting sense and is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. (canceled)

2. A system comprising:
an unmanned delivery vehicle;
a sensing system communicatively coupled to the unmanned delivery vehicle and configured to detect a location of a customer relative to a retail store; and
a device control circuit implemented on the unmanned delivery vehicle and communicatively coupled to the sensing system, the device control circuit configured to:
receive, from each of a plurality of customers located outside the retail store, a plurality of proposed product lists;
determine, for a first proposed product list of the plurality of proposed product lists, a first shopping route within the retail store;
receive an update to the first proposed product list during product retrieval from a first customer;
update the first proposed product list based on the update received during the product retrieval;
adjust the first shopping route based on the updated first proposed product list;
guide the unmanned delivery vehicle, using the sensing system, along the adjusted first shopping route to retrieve products based on the updated proposed product list; and
control the unmanned delivery vehicle to deliver retrieved products to the first customer associated with the first proposed product list received upon detecting arrival of the first customer at a designated pickup location via the sensing system.

3. The system of claim 2, wherein the sensing system comprises one or more sensors, the one or more sensors configured to provide sensor data used by the unmanned delivery vehicle to detect the arrival and determine the location of the customer relative to the retail store.

4. The system of claim 3, wherein the one or more sensors of the sensing system comprise one or more cameras configured to be used by the unmanned delivery vehicle to capture information about one or more products for identifying a product or confirming retrieval of the product.

5. The system of claim 2, wherein the device control circuit is further configured to control a point of sale system to complete a purchase transaction for the first customer for the retrieved products.

6. The system of claim 2, wherein the device control circuit is further configured to wirelessly communicate with a customer database, the customer database storing a plurality of primary customer accounts associated with different customers that have previously purchased products from one or more of multiple different retail stores including the retail store.

7. The system of claim 2, wherein the device control circuit is further configured to wirelessly communicate with an inventory management system of the retail store, wherein the inventory management system is configured to continuously maintain a current inventory of each product offered for sale.

8. The system of claim 2, wherein the device control circuit is further configured to determine a first suggested product list and a second suggested product list corresponding to the first customer and a second customer, respectively, each suggested product list being generated based on a corresponding proposed product list, a weighted average of a plurality of variables, and a set of product filtering rules applied using a current inventory and one or more other factors.

9. The system of claim 2, wherein the device control circuit is further configured to identify common locations between the first shopping route of the first customer and a second shopping route of a second customer to enable cooperative product retrieval between a plurality of unmanned vehicles and minimize a duration of respective shopping routes navigated by each unmanned vehicle.

10. The system of claim 2, wherein a memory implemented on the device control circuit stores a copy of a local inventory list, and wherein the device control circuit is configured to retrieve product availability data from a locally stored inventory list upon detecting a loss of connectivity to a retail store's inventory management system.

11. The system of claim 2, wherein the unmanned delivery vehicle includes a motor, wheels, location tracking and other local processing systems.

12. A method comprising:
detecting, by a sensing system communicatively coupled to an unmanned delivery vehicle, a location of a customer relative to a retail store;
receiving, by a device control circuit implemented on the unmanned delivery vehicle, from each of a plurality of customers located outside the retail store, a plurality of proposed product lists;
determining, by the device control circuit implemented on the unmanned delivery vehicle, for a first proposed product list of the plurality of proposed product lists, a first shopping route within the retail store;
receiving, by the device control circuit implemented on the unmanned delivery vehicle, an update to the first proposed product list during product retrieval from a first customer;
updating, by the device control circuit implemented on the unmanned delivery vehicle, the first proposed product list based on the update received during the product retrieval;
adjusting, by the device control circuit implemented on the unmanned delivery vehicle, the first shopping route based on the updated first proposed product list;
guiding the unmanned delivery vehicle, by the device control circuit implemented on the unmanned vehicle, using the sensing system, along the adjusted first shopping route to retrieve products based on the updated proposed product list; and
controlling, by the device control circuit implemented on the unmanned delivery vehicle, the unmanned delivery vehicle to deliver retrieved products to the first customer associated with the first proposed product list received upon detecting arrival of the first customer at a designated pickup location via the sensing system.

13. The method of claim 12, further comprising detecting the arrival and determining the location of the customer relative to the retail store, by the unmanned delivery vehicle using sensor data provided by one or more sensors of the sensing system.

14. The method of claim 13, further comprising capturing, by one or more cameras of the one or more sensors of the sensing system, information about one or more products for identifying a product or confirming retrieval of the product.

15. The method of claim 12, further comprising controlling, by the device control circuit, a point of sale system to complete a purchase transaction for the first customer for the retrieved products.

16. The method of claim 12, further comprising wirelessly communicating, by the device control circuit, with a customer database, wherein the customer database stores a plurality of primary customer accounts of different customers that have previously purchased products from one or more of multiple different retail stores including the retail store.

17. The method of claim 12, further comprising wirelessly communicating, by the device control circuit, with an inventory management system of the retail store, wherein the inventory management system is configured to continuously maintain a current inventory of each product offered for sale.

18. The method of claim 12, further comprising determining, by the device control circuit, a first suggested product list and a second suggested product list corresponding to the first customer and a second customer, respectively, each suggested product list being generated based on a corresponding proposed product list, a weighted average of a plurality of variables, and a set of product filtering rules applied using a current inventory and one or more other factors.

19. The method of claim 12, further comprising identifying, by the device control circuit, common locations between the first shopping route of the first customer and a second shopping route of a second customer to enable cooperative product retrieval between a plurality of unmanned vehicles and minimize a duration of respective shopping routes along which the unmanned delivery vehicle is guided.

20. The method of claim 12, further comprising storing, by a memory implemented on the device control circuit, a copy of a local inventory list, wherein the device control circuit is configured to retrieve product availability data from a locally stored inventory list upon detecting a loss of connectivity to a retail store's inventory management system.

21. The method of claim 12, wherein the unmanned delivery vehicle includes a motor, wheels, location tracking and other.
